(19) United States
(12) Patent Application Publication
(10) Pub. No.: US 2007/0265377 A1
(43) Pub. Date: Nov. 15, 2007

(54) Chemical modifier for properties enhancement of olefin polymers or copolymers thereof

(76) Inventor: Yung-Chin Tsou, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/429,938

(22) Filed: May 9, 2006

(51) Int. Cl. C08K 3/34

(52) U.S. Cl. 524/394; 524/425; 524/451; 524/447

(57) ABSTRACT

A modifier for modifying olefin polymers or copolymers thereof. The modifier is composed of a modifying material, a carrier and a medium. The modifying material is a transition metallic acid. The carrier has a certain diameter for evenly spreading the modifying material into the polymer monomers to be modified. The medium serves to speed the copolymerization reaction of the modifying material and the polymer monomers to be modified.

### BACKGROUND OF THE INVENTION

The present invention is related to a polymer, and more specifically to a chemical modifier for properties enhancement of the olefin polymers or copolymers thereof.

It is a trend over the world to protect the environment and minimize pollution of the environment by minimizing the polymer waste disposal. The structures of the polymer products have to be modified to make it easier to decompose the polymer products in natural environment after disposal. There are five categories of decomposition, that is, biological decomposition, photodecomposition, oxidation biological decomposition, hydrolysis and chemical resolution.

Substantially, the so-called biological decomposition means that a decomposable natural polymer such as starch is added into the indecomposable polymer such as polyethylene. On one hand, after the natural polymer is decomposed in natural environment, the texture of the indecomposable polymer becomes porous and is weakened. Also, the surface area of the polymer is enlarged. On the other hand, fat or fatty acid autoxidant and the natural metallic salts react on each other to produce peroxides for breaking down the molecular chains of the indecomposable polymer such as polyethylene. However, the natural polymer such as starch is easy to absorb water and be hydrated.

The photodecomposition means that in manufacturing procedure, a suitable photosensitive agent is added into the indecomposable polymer such as polyethylene instead of the stabilizer. By means of this measure, the indecomposable polymer such as polyethylene will decompose under the effect of ultraviolet ray. However, the added photosensitive agent will contaminate the environment after the products are disposed.

### SUMMARY OF THE INVENTION

It is therefore a primary objective the present invention to provide a modifier for changing the properties of olefin polymers or copolymers thereof. The modifier is capable to modify the polymer to such extent that the polymer becomes more easily decomposable in natural environment after use and disposed.

It is a further objective of the present invention to provide the above modifier for modifying olefin polymers or copolymers thereof. The modifier can enhance the mechanical properties of the polymer that the modified polymer has better elasticity and strength so that the amount or thickness of the used polymer product can be reduced.

It is still a further objective of the present invention to provide the above modifier for modifying olefin polymers or copolymers thereof. During the using life period of the polymer, the polymer has stable quality and better strength properties. Only when the using life period expires, the polymer will start to decompose in natural environment.

According to the above objects, the modifier for modifying olefin polymers or copolymers thereof of the present invention contains a modifying material which is a transition metallic acid.

### DETAILED DESCRIPTION OF THE PREFERRED EMBODIMENTS

The modifier for modifying olefin polymers or copolymers thereof of the present invention is composed of a modifying material, a carrier and a medium.

The modifying material is one of the following transition metallic acids: ferric stearate, manganese stearate, cobalt stearate, cerium stearate, cupric stearate, nickel stearate, etc. or a composition thereof. For example, the modifying material can be ferric stearate having a chemical structural formula as follows:

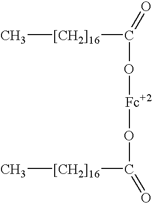

The carrier is calcium carbonate, kaolin, silicon powder or talc powder.

The medium is one of vinyl acrylic copolymer (EM), vinyl methyl acrylic ester (EMA) and EMM or a composition of at least two thereof.

In this embodiment, the medium is EM having a chemical structural formula as follows:

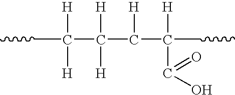

To speak detailedly, the carrier is coated with the modifying material. The carrier has a smaller diameter and a certain flowability, or processability whereby the modifying material can be evenly spread. Substantially, the diameter of the carrier is within 250 micrometers˜1 nanometer. The medium serves to speed the copolymerization reaction of the modifying material and the polymer monomers to be modified. Accordingly, the medium is a compound highly compatible with the molecular structure of the polymer to be modified. For example, for modifying polyethylene or polypropylene, the medium preferably has a molecular structure containing reaction groups such as double-bond oxygen, methyl group and hydroxyl group. That is, the medium can be EM, EMA or EMM.

The modifier with the above components is fully mixed with the polymer monomer to be modified. The weight percentage of the modifier to the polymer to be modified is under 10%. Through the polymerization reaction, the modifier and the polymer monomer to be modified are polymerized. Under such reaction mechanism, the modifier can achieve the following effects:
1. The modifier forms side chains and branched chains in the molecular structural formula of the polymer to be modified. Therefore, the elasticity and strength of the polymer are enhanced. Under the same requirement for strength, the amount of the used polymer can be reduced. For example, with the same strength, the polymer product can be thinner so as to achieve the object of environmental protection.
2. Due to the transition metals and double-bond oxygen in the side chains and branched chains of the modified polymer, when the modified polymer contacts with the natural environment and oxidizes and decomposes, the generated heat will expedite the formation of the transition metallic peroxide and destroy the hydrocarbon bonds of the polymer. Therefore, the polymer can be decomposed.
3. The carrier is able to evenly spread the modifying material in the polymer to be modified. In addition, the carrier can fill into the non-crystalline parts of the polymer. This can also enhance the strength of the polymer.
4. When the modifying material takes part in the polymerization reaction of the polymer to be modified, the medium serves as a bridge in the molecular structure between the OH group of the modifying material and the hydrocarbon radical of the polymer. Therefore, the reaction of the modifying material and the polymer can be speeded so as to ensure that the modifying material properly bonds with the polymer.

In conclusion, the modifier is able to strengthen the polymer to be modified. In addition, the modifier forms breakable reaction groups bonded with the molecular structure of the polymer. The decomposition of the polymer will not take place shortly. Only after a certain period of time, the decomposition of the polymer will be initiated under action of oxygen. During the using life period of the polymer, the polymer has stable quality and better strength. Only when the using life period expires, the polymer will start to decompose. Therefore, by means of the modifying material, the polymer can be naturally decomposed to achieve the object of environmental protection.

The above embodiments are only used to illustrate the present invention, not intended to limit the scope thereof. Many modifications of the above embodiments can be made without departing from the spirit of the present invention.

What is claimed is:

1. 1. A modifier for modifying olefin polymers or copolymers thereof, comprising a modifying material which is a transition metallic acid.

2. The modifier for modifying olefin polymers or copolymers thereof as claimed in claim 1, wherein the modifying material is one of ferric stearate, manganese stearate, cobalt stearate, cerium stearate, cupric stearate and nickel stearate or a composition thereof.

3. The modifier for modifying olefin polymers or copolymers thereof as claimed in claim 1, further comprising a carrier with a predetermined diameter for spreading the modifying material.

4. The modifier for modifying olefin polymers or copolymers thereof as claimed in claim 3, wherein the carrier is calcium carbonate, kaolin, silicon powder or talc powder.

5. The modifier for modifying olefin polymers or copolymers thereof as claimed in claim 3, wherein the diameter of the carrier is smaller than 250 micrometers.

6. The modifier for modifying olefin polymers or copolymers thereof as claimed in claim 1, further comprising a predetermined amount of medium, the medium having a molecular structure containing double-bond oxygen and methyl group.

7. The modifier for modifying olefin polymers or copolymers thereof as claimed in claim 6, wherein the medium is one of vinyl acrylic copolymer (EM), vinyl methyl acrylic ester (EMA) and EMM or a composition of at least two thereof.
